(19) United States
(12) Patent Application Publication
(10) Pub. No.: US 2003/0018964 A1
(43) Pub. Date: Jan. 23, 2003

(54) Object model and framework for installation of software packages using a distributed directory

(75) Inventors: James E. Fox, Apex, NC (US); Robert C. Leah, Cary, NC (US); John R. McGarvey, Apex, NC (US)

Correspondence Address: Gerald R. Woods, IBM Corporation T81/503, PO Box 12195, Research Triangle Park, NC, 27709, US

(73) Assignee: International Business Machines Corporation, Armonk, NY (US)

(21) Appl. No.: 09/908,927

(22) Filed: Jul. 19, 2001

(51) Int. Cl. G06F 9/445

(52) U.S. Cl. 717/177; 717/170

(57) ABSTRACT

Methods, systems, and computer program products for improving installation of software packages using a directory (such as a Lightweight Directory Access Protocol, or “LDAP”, directory). A model and framework are described, where the objects of the data model may be uncoupled from the framework, allowing individual objects to be separately stored and retrieved in the directory is association with access rights or privileges. Multiple versions of each object may therefore be created and stored, and may be easily retrieved using the built-in mechanisms of the directory, when access rights which are appropriate for a particular requester are known. Optionally, built-in authentication mechanisms of the directory may be used to authenticate the requester.

### RELATED INVENTIONS

The present invention is related to U.S. Pat. No. ______ (Ser. No. 09/669,227, filed Sep. 25, 2000), titled “Object Model and Framework for Installation of Software Packages Using JavaBeans™”; U.S. Pat. No. ______ (Ser. No. 09/707,656, filed Nov. 07, 2000), titled “Object Model and Framework for Installation of Software Packages Using Object Descriptors”, U.S. Pat. No. ______ (Ser. No. 09/707,545, filed Nov. 07, 2000), titled “Object Model and Framework for Installation of Software Packages Using Object REXX”; U.S. Pat. No. ______ (Ser. No. 09/707,700, filed Nov. 07, 2000), titled “Object Model and Framework for Installation of Software Packages Using Structured Documents”; and U.S. Pat. No. ______ (Ser. No. 09/879,694, filed Jun. 12, 2001), titled “Efficient Installation of Software Packages”. These inventions are commonly assigned to the International Business Machines Corporation (“IBM”) and are hereby incorporated herein by reference.

### BACKGROUND OF THE INVENTION

1. Field of the Invention

The present invention relates to a computer system, and deals more particularly with methods, systems, and computer program products for improving the installation of software packages by using a distributed directory (such as a Lightweight Directory Access Protocol, or “LDAP”, directory).

2. Description of the Related Art

Use of computers in today's society has become pervasive. The software applications to be deployed, and the computing environments in which they will operate, range from very simple to extremely large and complex. The computer skills base of those responsible for installing the software applications ranges from novice or first-time users, who may simply want to install a game or similar application on a personal computer, to experienced, highly-skilled system administrators with responsibility for large, complex computing environments. The process of creating a software installation package that is properly adapted to the skills of the eventual installer, as well as to the target hardware and software computing environment, and also the process of performing the installation, can therefore be problematic.

In recent decades, when the range of computing environments and the range of user skills was more constant, it was easier to target information on how software should be installed. Typically, installation manuals were written and distributed with the software. These manuals provided textual information on how to perform the installation of a particular software application. These manuals often had many pages of technical information, and were therefore difficult to use by those not having considerable technical skills. “User-friendliness” was often overlooked, with the description of the installation procedures focused solely on the technical information needed by the software and system.

With the increasing popularity of personal computers came a trend toward easier, more user-friendly software installation, as software vendors recognized that it was no longer reasonable to assume that a person with a high degree of technical skill would be performing every installation process. However, a number of problem areas remained because of the lack of a standard, consistent approach to software installation across product and vendor boundaries. These problems, which are addressed in the related inventions, will now be described.

The manner in which software packages are installed today, and the formats of the installation images, often varies widely depending on the target platform (i.e. the target hardware, operating system, etc.), the installation tool in use, and the underlying programming language of the software to be installed, as well as the natural language in which instructions are provided and in which input is expected. When differences of these types exist, the installation process often becomes more difficult, leading to confusion and frustration for users. For complex software packages to be installed in large computing systems, these problems are exacerbated. In addition, developing software installation packages that attempt to meet the needs of many varied target environments (and the skills of many different installers) requires a substantial amount of time and effort.

One area where consistency in the software installation process is advantageous is in knowing how to invoke the installation procedure. Advances in this area have been made in recent years, such that today, many software packages use some sort of automated, self-installing procedure. For example, a file (which, by convention, is typically named “setup.exe” or “install.exe”) is often provided on an installation medium (such as a diskette or CD-ROM). When the installer issues a command to execute this file, an installation program begins. Issuance of the command may even be automated in some cases, whereby simply inserting the installation medium into a mechanism such as a CD-ROM reader automatically launches the installation program.

These automated techniques are quite beneficial in enabling the installer to get started with an installation. However, there are a number of other factors which may result in a complex installation process, especially for large-scale applications that are to be deployed in enterprise computing environments. For example, there may be a number of parameters that require input during installation of a particular software package. Arriving at the proper values to use for these parameters may be quite complicated, and the parameters may even vary from one target machine to another. There may also be a number of prerequisites and/or co-requisites, including both software and hardware specifications, that must be accounted for in the installation process. There may also be issues of version control to be addressed when software is being upgraded. An entire suite or package of software applications may be designed for simultaneous installation, leading to even more complications. In addition, installation procedures may vary widely from one installation experience to another, and the procedure used for complex enterprise software application packages may be quite different from those used for consumer-oriented applications.

Furthermore, these factors also affect the installation package developers, who must create installation packages which properly account for all of these variables. Today, installation packages are typically created using vendor-specific and product-specific installation software. Adding to or modifying an installation package can be quite complicated, as it requires determining which areas of the installation source code must be changed, correctly making the appropriate changes, and then recompiling and retesting the installation code. End-users may be prevented from adding to or modifying the installation packages in some cases, limiting the adaptability of the installation process. The lack of a standard, robust product installation interface therefore results in a labor-intensive and error-prone installation package development procedure.

Other practitioners in the art have recognized the need for improved software installation techniques. In one approach, generalized object descriptors have been adapted for this purpose. An example is the Common Information Model (CIM) standard promulgated by The Open Group™ and the Desktop Management Task Force (DTMF). The CIM standard uses object descriptors to define system resources for purposes of managing systems and networks according to an object-oriented paradigm. However, the object descriptors which are provided in this standard are very limited, and do not suffice to drive a complete installation process. In another approach, system management functions such as Tivoli® Software Distribution, Computer Associates Unicenter TNG®, Intel LANDesk® Management Suite, and Novell ZENWorks™ for Desktops have been used to provide a means for describing various packages for installation. Unfortunately, these descriptions lack cross-platform consistency, and are dependent on the specific installation tool and/or system management tool being used. In addition, the descriptions are not typically or consistently encapsulated with the install image, leading to problems in delivering bundle descriptions along with the corresponding software bundle, and to problems when it is necessary to update both the bundle and the description in a synchronized way. (The CIM standard is described in “Systems Management: Common Information Model (CIM)”, Open Group Technical Standard, C804 ISBN 1-85912-255-8, August 1998. “Tivoli” is a registered trademark of Tivoli Systems Inc. “Unicenter TNG” is a registered trademark of Computer Associates International, Inc. “LANDesk” is a registered trademark of Intel Corporation. “ZENWorks” is a trademark of Novell, Inc.)

The related inventions teach use of an object model and framework for software installation packages and address many of these problems of the prior art, enabling the installation process to be simplified for software installers as well as for the software developers who must prepare their software for an efficient, trouble-free installation, and define several techniques for improving installation of software packages. While the techniques disclosed in the related inventions provide a number of advantages and are functionally sufficient, there may some situations in which the techniques disclosed therein may be improved upon.

### SUMMARY OF THE INVENTION

An object of the present invention is to provide an improved technique for installation of software packages.

It is another object of the present invention to provide this technique using a model and framework that provides for a consistent and efficient installation across a wide variety of target installation environments, where objects created according to that model and framework take advantage of distributed directory facilities.

Another object of the present invention is to provide a software installation technique that enables multiple versions of an installation package to be flexibly and efficiently assembled from multiple versions of its objects, according to different roles of intended receivers of the installation package.

Still another object of the present invention is to provide the improved software installation technique wherein an intended receiver is authenticated prior to delivery of an installation package.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for improving installation of software packages using distributed directory facilities. This technique comprises: defining an object model representing a plurality of components of a software installation package, wherein each component comprises a plurality of objects; instantiating at least one version of each of the objects, wherein a plurality of versions of selected ones of the objects may be instantiated to reflect differing access rights of potential requesters of the package; and storing the instantiated objects in a directory, wherein the versions of the objects are associated with the differing access rights.

In one aspect, the technique may further comprise populating the instantiated objects with attributes and methods to describe a particular software installation package. In another aspect, the technique may further comprise receiving a request from a particular requester for a selected software installation package; determining access rights of the particular requester; and retrieving the selected software installation package from the directory, wherein the retrieved package is dynamically assembled from the stored objects based upon the determined access rights. In this latter case, the technique may further comprise authenticating the particular requester, in response to receiving the request; and determining the access rights and retrieving the selected software installation package only if the authentication succeeds.

The technique may further comprise installing the retrieved software installation package.

The instantiated objects may be JavaBeans, and the directory is preferably an LDAP directory.

The present invention will now be described with reference to the following drawings, in which like reference numbers denote the same element throughout.

### BRIEF DESCRIPTION OF THE DRAWINGS

FIG. 1 is a block diagram of a computer hardware environment in which the present invention may be practiced;

FIG. 2 is a diagram of a networked computing environment in which the present invention may be practiced,

FIG. 3 illustrates an object model that may be used for defining software components to be included in an installation package, according to the related inventions, and which may be improved upon according to the present invention;

FIG. 4 depicts an object model that may be used for defining a suite, or package, of software components to be installed, according to the related inventions, and which may be improved upon according to the present invention;

FIGS. 5 and 6 depict resource bundles that may be used for specifying various types of product and variable information to be used during an installation, according to an embodiment of the related inventions; and

FIGS. 7-10 depict flowcharts illustrating logic with which a software installation package may be processed, according to preferred embodiments of the present invention.

### DESCRIPTION OF PREFERRED EMBODIMENTS

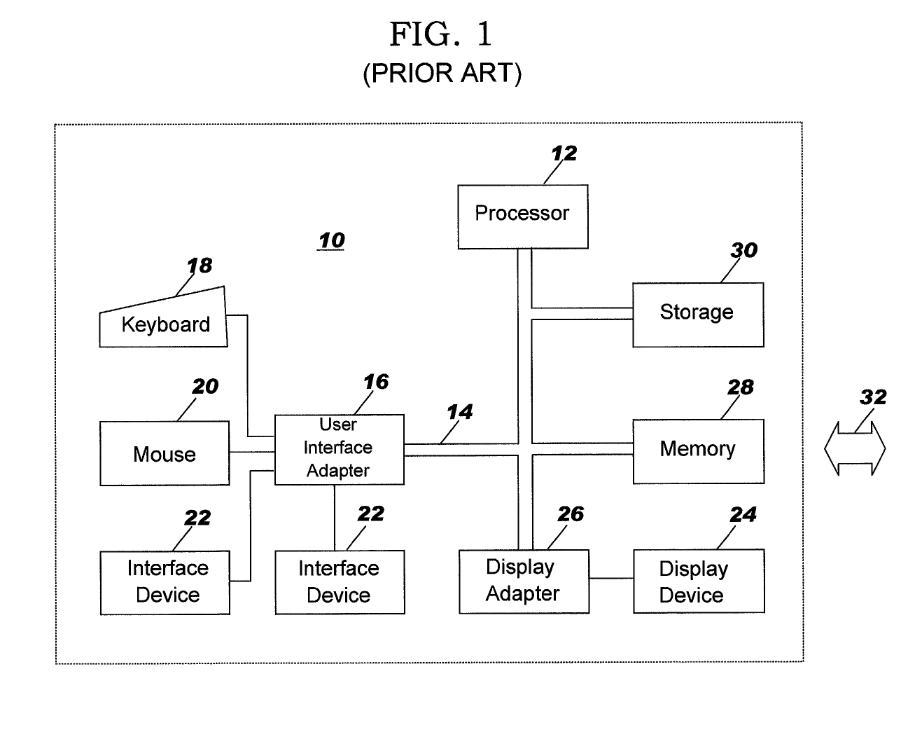

FIG. 1 illustrates a representative computer hardware environment in which the present invention may be practiced. The device 10 illustrated therein may be a personal computer, a laptop computer, a server or mainframe, and so forth. The device 10 typically includes a microprocessor 12 and a bus 14 employed to connect and enable communication between the microprocessor 12 and the components of the device 10 in accordance with known techniques. The device 10 typically includes a user interface adapter 16, which connects the microprocessor 12 via the bus 14 to one or more interface devices, such as a keyboard 18, mouse 20, and/or other interface devices 22 (such as a touch sensitive screen, digitized entry pad, etc.). The bus 14 also connects a display device 24, such as an LCD screen or monitor, to the microprocessor 12 via a display adapter 26. The bus 14 also connects the microprocessor 12 to memory 28 and long-term storage 30 which can include a hard drive, diskette drive, tape drive, etc.

The device 10 may communicate with other computers or networks of computers, for example via a communications channel or modem 32. Alternatively, the device 10 may communicate using a wireless interface at 32, such as a CDPD (cellular digital packet data) card. The device 10 may be associated with such other computers in a local area network (LAN) or a wide area network (WAN), or the device 10 can be a client in a client/server arrangement with another computer, etc. All of these configurations, as well as the appropriate communications hardware and software which enable their use, are known in the art.

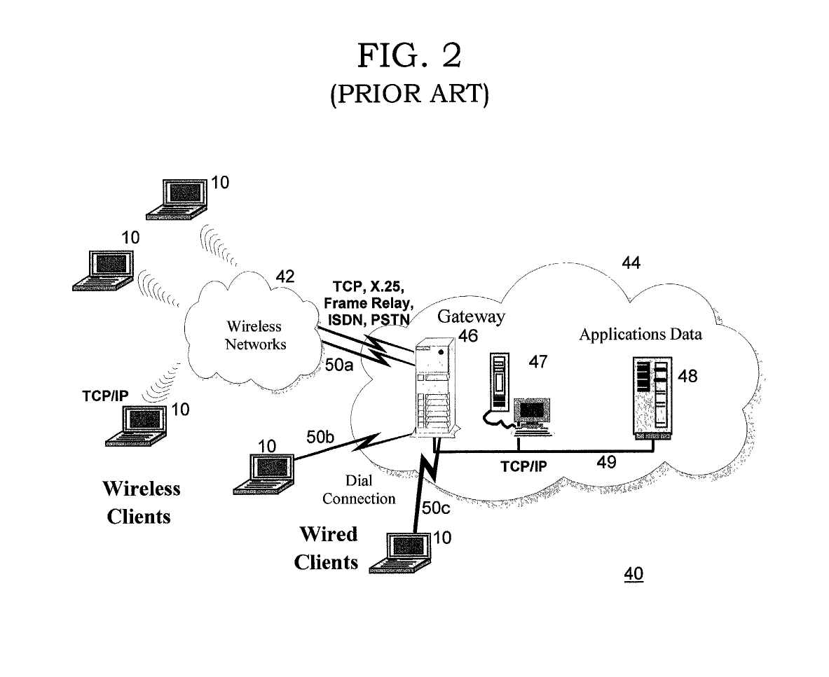

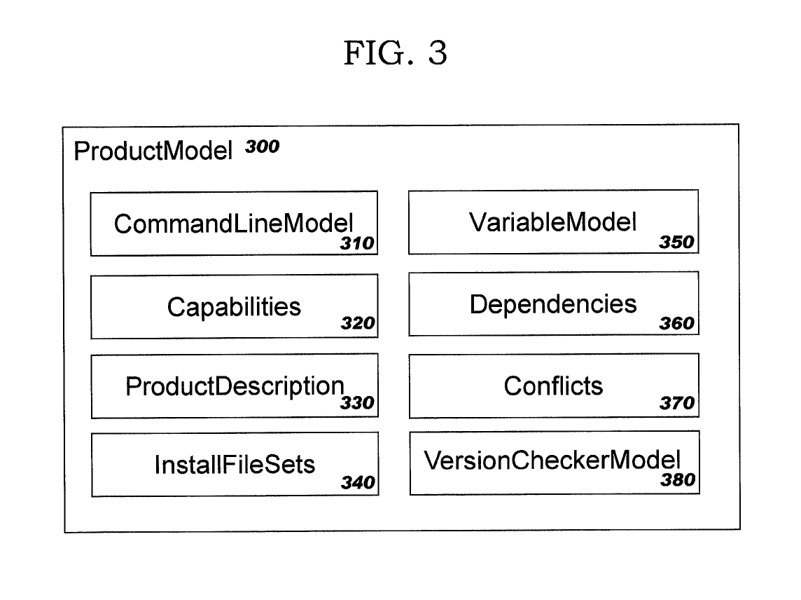

FIG. 2 illustrates a data processing network 40 in which the present invention may be practiced. The data processing network 40 may include a plurality of individual networks, such as wireless network 42 and network 44, each of which may include a plurality of devices 10. Additionally, as those skilled in the art will appreciate, one or more LANs may be included (not shown), where a LAN may comprise a plurality of intelligent workstations or similar devices coupled to a host processor.

Still referring to FIG. 2, the networks 42 and 44 may also include mainframe computers or servers, such as a gateway computer 46 or application server 47 (which may access a data repository 48). A gateway computer 46 serves as a point of entry into each network 44. The gateway 46 may be coupled to another network 42 by means of a communications link 50a. The gateway 46 may also be directly coupled to one or more devices 10 using a communications link 50b, 50c. Further, the gateway 46 may be indirectly coupled to one or more devices 10. The gateway computer 46 may also be coupled 49 to a storage device (such as data repository 48). The gateway computer 46 may be implemented utilizing an Enterprise Systems Architecture/370™ computer available from the International Business Machines Corporation (“IBM”) an Enterprise Systems Architecture/390® computer, etc. Depending on the application, a midrange computer, such as an Application System/400® (also known as an AS/400®) may be employed. (“Enterprise Systems Architecture/370” is a trademark of IBM; “Enterprise Systems Architecture/390”, “Application System/400”, and “AS/400” are registered trademarks of IBM.)

Those skilled in the art will appreciate that the gateway computer 46 may be located a great geographic distance from the network 42, and similarly, the devices 10 may be located a substantial distance from the networks 42 and 44. For example, the network 42 may be located in California, while the gateway 46 may be located in Texas, and one or more of the devices 10 may be located in New York. The devices 10 may connect to the wireless network 42 using a networking protocol such as the Transmission Control Protocol/Internet Protocol (“TCP/IP”) over a number of alternative connection media, such as cellular phone, radio frequency networks, satellite networks, etc. The wireless network 42 preferably connects to the gateway 46 using a network connection 50a such as TCP or LDP (User Datagram Protocol) over IP, X.25, Frame Relay, ISDN (Integrated Services Digital Network), PSTN (Public Switched Telephone Network), etc. The devices 10 may alternatively connect directly to the gateway 46 using dial connections 50b or 50c. Further, the wireless network 42 and network 44 may connect to one or more other networks (not shown), in an analogous manner to that depicted in FIG. 2.

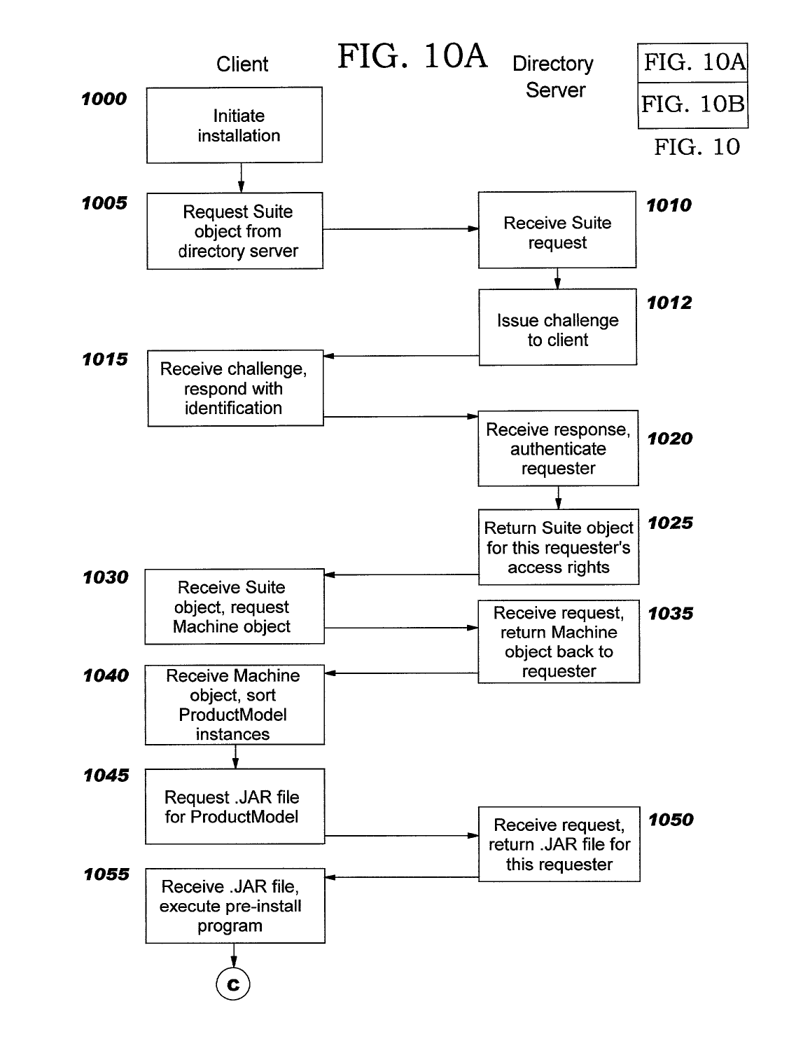

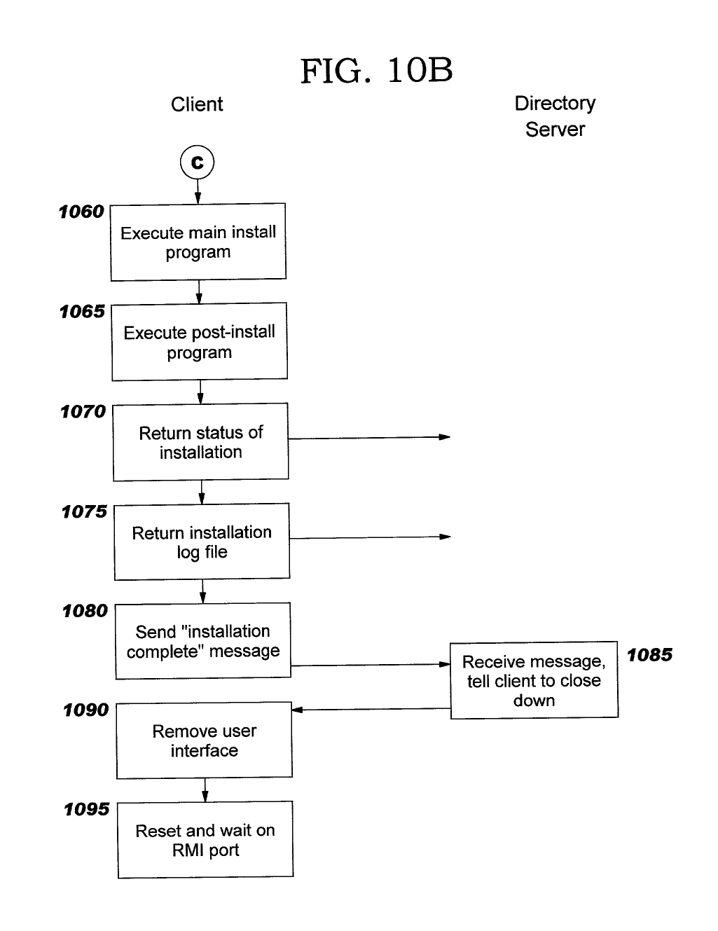

A distributed directory facility, which is referred to hereinafter as a Lightweight Directory Access Protocol (“LDAP”) directory or directory server for ease of reference, may be installed on one or more devices in the network environment of FIG. 2. For example, application server 47 may include an LDAP directory. Or, application server 47 may access another device on which an LDAP directory is installed. Data repositories used by the LDAP directory may reside at one or more locations within the environment. (Note that the term “distributed directory” is used herein for purposes of illustration and not of limitation: the present invention may be used with directory implementations which do not span more than one device.) Furthermore, LDAP directory facilities may be available on end-user devices such as device 10. An example of this latter case is the Windows® 2000 operating system from Microsoft Corporation, which uses LDAP directory facilities for its “Active Directory”. Commercial LDAP directory implementations are widely available, and are well known in the art. A detailed description of lit such implementations is therefore not deemed necessary for purposes of the present invention. Preferred embodiments of the present invention may use any such LDAP directory implementation which supports basic functions of (1) data storage and retrieval based upon defined access rights or privileges and (2) authentication of requesters. (Alternative embodiments do not require authentication of requesters, as will be described below with reference to FIG. 10.) Note that while preferred embodiments use LDAP directory facility that may be distributed across multiple devices, an implementation which operates from a single device is also within the scope of the present invention. In addition, while preferred embodiments are described in terms of access rights of a “user” (or equivalently, of a “requester”), this is for purposes of illustration and not of limitation: alternatively, access rights or permissions which are appropriate for a requester may be determined with reference to other entities. (For example, access rights may be associated with a role, with an authority level, or with a specific user identification, and so forth.) It should also be noted that the techniques of the present invention do not require changing the commercially-available LDAP directory implementation.

In preferred embodiments, the present invention is implemented in software. Software programming code which embodies the present invention is typically accessed by the microprocessor 12 (e.g. of device 10 and/or server 47) from long-term storage media 30 of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory 28, and accessed by the microprocessor 12 using the bus 14. The techniques and methods for embodying software programming code in memory, on physical media, and/or distributing software code via networks are well known and will not be further discussed herein.

A user of the present invention (e.g. a software installer or a software developer creating a software installation package) may connect his computer to a server using a wireline connection, or a wireless connection. (Alternatively, the present invention may be used in a stand-alone mode without having a network connection.) Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line, using a LAN card such as Token Ring or Ethernet; using a cellular modem to establish a wireless connection; etc. The user's computer may be any type of computer processor, including laptop, handheld or mobile computers; vehicle-mounted devices; desktop computers; mainframe computers; etc., having processing capabilities (and communication capabilities, when the device is network-connected). The remote server, similarly, can be one of any number of different types of computer which have processing and communication capabilities. These techniques are well known in the art, and the hardware devices and software which enable their use are readily available. Hereinafter, the user's computer will be referred to equivalently as a “workstation”, “device”, or “computer”, and use of any of these terms or the term “server” refers to any of the types of computing devices described above.

When implemented in software, the present invention may be implemented as one or more computer software programs. The software is preferably implemented using an object-oriented programming language, such as the Java™ programming language. The model which is used for describing the aspects of software installation packages is preferably designed using object-oriented modeling techniques of an object-oriented paradigm. In preferred embodiments, the objects which are based on this model, and which are created to describe the installation aspects of a particular installation package, may be specified using a number of approaches, including but not limited to: JavaBeans™ or objects having similar characteristics; structured markup language documents (such as Extensible Markup Language, or “XML”, documents); object descriptors of an object modeling notation; or Object REXX or objects in an object scripting language having similar characteristics. (“Java” and “JavaBeans” are trademarks of Sun Microsystems, Inc.) For purposes of illustration and not of limitation, the following description of preferred embodiments refers to objects which are JavaBeans.

An implementation of the present invention may be executing in a Web environment, where software installation packages are downloaded using a protocol such as the HyperText Transfer Protocol (HTTP) from a Web server to one or more target computers which are connected through the Internet. Alternatively, an implementation of the present invention may be executing in other non-Web networking environments (using the Internet, a corporate intranet or extranet, or any other network) where software packages are distributed for installation using techniques such as Remote Method Invocation (“RMI”) or Common Object Request Broker Architecture (“CORBA”). Configurations for the environment include a client/server network, as well as a multi-tier environment. Or, as stated above, the present invention may be used in a stand-alone environment, such as by an installer who wishes to install a software package from a locally-available installation media rather than across a network connection. Furthermore, it may happen that the client and server of a particular installation both reside in the same physical device, in which case a network connection is not required. A software developer who prepares a software package for installation using the present invention may use a network-connected workstation, a stand-alone workstation, or any other similar computing device. These environments and configurations are well known in the art.

The target devices with which the present invention may be used advantageously include end-user workstations, mainframes or servers on which software is to be loaded, or any other type of device having computing or processing capabilities (including “smart” appliances in the home, cellular phones, personal digital assistants or “PDAs”, dashboard devices in vehicles, etc.).

Preferred embodiments of the present invention will now be discussed in more detail with reference to FIGS. 3 through 10.

The present invention uses an object model for software package installation, in which a framework is defined for creating one or more objects which comprise each software installation package. The present invention discloses a technique for using that object model to enable multiple versions of an installation package to be flexibly and efficiently assembled from multiple versions of its objects, according to different access rights of intended receivers of the installation package. The present invention also discloses optional authentication of the receivers prior to assembling an installing package for distribution thereto. These techniques will be described in more detail herein. Preferred embodiments of the software object model and framework are described in the related inventions. As disclosed therein, each installation object preferably comprises object attributes and methods for the following:

1) A manifest, or list, of the files comprising the software package to be installed.

2) Information on how to access the files comprising the software package. This may involve:

a) explicit encapsulation of the files within the object, or

b) links that direct the installation process to the location of the files (which may optionally include a specification of any required access protocol, and of any compression or unwrapping techniques which must be used to access the files).

3) Default response values to be used as input for automatically responding to queries during customized installs, where the default values are preferably specified in a response file. The response file may specify information such as how the software package is to be subset when it is installed, where on the target computer it is to be installed, and other values to customize the behavior of the installation process.

4) Methods, usable by a systems administrator or other software installation personnel, for setting various response values or for altering various ones of the default response values to tailor a customized install.

5) Validation methods to ensure the correctness and internal consistency of a customization and/or of the response values otherwise provided during an installation.

6) Optionally, localizable strings (i.e. textual string values that may be translated, if desired, in order to present information to the installer in his preferred natural language).

7) Instructions (referred to herein as the “command line model”) on how the installation program is to be invoked, and preferably, how return code information or other information related to the success or failure of the installation process may be obtained.

8) The capabilities of the software package (e.g. the functions it provides).

9) A specification of the dependencies, including prerequisite or co-requisites, of the software package (such as the required operating system, including a particular level thereof; other software functions that must be present if this package is to be installed; software functions that cannot be present if this package is installed; etc.).

The present invention uncouples the objects of the data model from the framework, allowing individual objects to be separately stored and retrieved, as will be described in more detail below. Advantages of storing installation objects in a directory may therefore be realized, where multiple versions of each object may be created and stored for unique situations, and may be easily retrieved using the built-in mechanisms of the directory. To illustrate use of these techniques, suppose a company wishes to install a Lotus® Domino™ solution throughout its enterprise. A Lotus Notes® client application is used to interface with a Domino server. Lotus Notes clients are available in three different versions. A basic or standard version includes functionality for checking mail and accessing databases. A version known as “Lotus Notes Designer” includes the functionality of the standard version as well as an ability to create and maintain databases. A third version known as “Lotus Notes Administrator” provides all the features of the other two, but also allows administration of accounts and users. Suppose that in this large company, all users log onto their computers using some sort of LDAP directory facility (such as the previously-mentioned Windows 2000 operating system). In this example, the model and framework described herein may be used to create three different versions of one or more objects from an installation package for installing the Domino solution throughout the enterprise: then, depending on a particular user's role (e.g. end-user, developer, or administrator), his or her access privileges will be determined and a corresponding installation suite which is dynamically built from the appropriate objects will be automatically retrieved from the directory and distributed to the user's client device for installation.

Using the techniques of the present invention also enables the installation objects for a particular suite to be stored in multiple locations across a network, if desired, rather than requiring a fixed installation package to be stored in a centralized location. This may result in a more efficient installation and, when a large-scale installation is underway, may reduce the likelihood of creating bottlenecks in the network. Furthermore, distributing objects enables the data model to be updated more easily when needed, as each object may be separately retrieved from the directory, modified, and stored again.

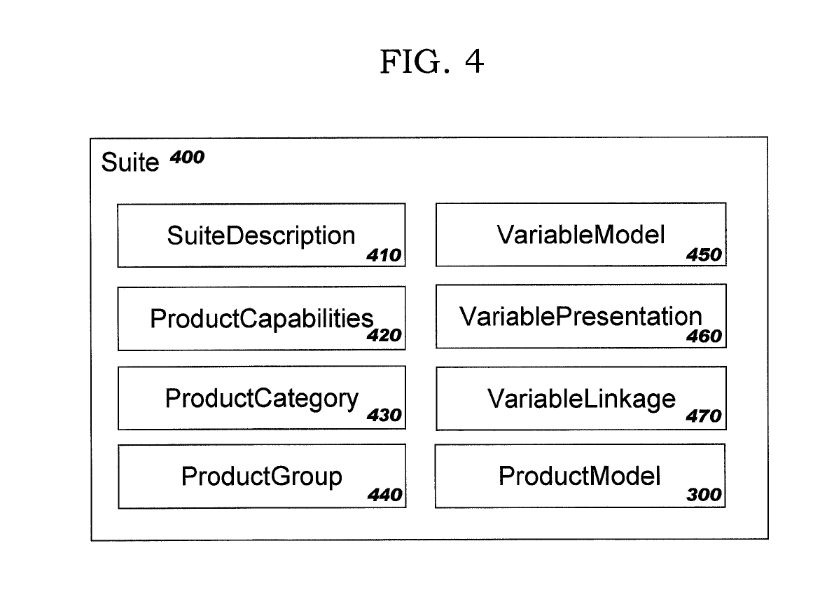

A preferred embodiment of the object model used for defining installation packages as disclosed in the related inventions, and enhancements thereto which may be made for the present invention, is depicted in FIGS. 3 and 4. FIG. 3 illustrates a preferred object model to be used for describing each software component present in an installation package. A graphical containment relationship is illustrated, in which (for example) ProductModel 300 is preferably a parent of one or more instances of CommandLineModel 310, Capabilities 320, etc. FIG. 4 illustrates a preferred object model that may be used for describing a suite comprising all the components present in a particular installation package. (It should be noted, however, that the model depicted in FIGS. 3 and 4 is merely illustrative of one structure that may be used to represent installation packages according to the present invention. Other subclasses may be used alternatively, and the hierarchical relationships among the subclasses may be altered, without deviating from the inventive concepts disclosed herein.) A version of the object model depicted by FIGS. 3 and 4 has been described in detail in the related inventions. This description is presented here as well in order to establish a context for the present invention. Modifications to this object model that may be used for supporting the present invention are also described herein in context of the overall model.

Note that each of the related inventions may differ slightly in the terms used to describe the object model and the manner in which it is processed. For example, the related invention pertaining to use of structured documents refers to elements and subelements, and storing information in document form, whereas the related invention pertaining to use of JavaBeans refers to classes and subclasses, and storing information in resource bundles. As another example, the related inventions disclose several alternative techniques for specifying information for installation objects, including: use of resource bundles when using JavaBeans; use of structured documents encoded in a notation such as the Managed Object Format (“MOF”) or XML; and use of properties sheets. These differences will be well understood by one of skill in the art. For ease of reference when describing the present invention, the discussion herein is aligned with the terminology used in the JavaBeans-based disclosure; it will be obvious to those of skill in the art how this description may be adapted in terms of the other related inventions.

A ProductModel 300 object class is defined, according to the related inventions, which serves as a container for all information relevant to the installation of a particular software component. The contained information is shown generally at 310 through 380, and comprises the information for a particular component installation, as will now be described in more detail. According to the present invention, this containment relationship is a logical relationship rather than physical. That is, multiple versions of one or more of the objects which comprise ProductModel 300 (e.g. instances of Capabilities 320, instances of InstallFileSets 340, and so forth) may be created and separately stored in a directory. In preferred embodiments, the multiple versions correspond to the access rights associated with different users, authority levels, roles, etc. An appropriate version of an object may then be dynamically selected, at run-time, once the target user's access rights are known, and used to assemble a complete ProductModel instance. As an example of creating multiple versions of objects based on access rights, one instance of InstallFileSets may specify the files to be installed for a user of the Domino solution described earlier who has an end-user role, whereas a different instance may be created to reflect the files to be installed for users in the developer role and still another instance may be created specifying the files for users in the administrative role. Determining the user's access rights prevents distributing code that should not be made available to the target user, and may in many cases reduce the size of the installation image which is sent to a majority of users.

Note that while preferred embodiments enable instances of any subclasses of ProductModel (and of Suite 400, discussed below with reference to FIG. 4) to be separately stored as one or more versions, in some implementations it may be preferable to allow the model to be decomposed at a different granularity, and such alternative embodiments are within the scope of the present invention. For example, it might be desirable to implement the present invention such that multiple versions are not supported for instances of VariableModel class 350. It may also happen that multiple versions of all objects are supported, but are simply not needed in some uses of the present invention. The data model as disclosed herein flexibly adapts to many different installation scenarios, allowing reuse of shared objects or definition of distinct versions, as appropriate.

Referring again to FIG. 3, a CommandLineModel class 310 is used for specifying information about how to invoke an installation (i.e. the “command line” information, which includes the command name and any arguments). In preferred embodiments of the object model disclosed in the related inventions, CommandLineModel is an abstract class, and has subclasses for particular types of installation environments. These subclasses preferably understand, inter alia, how to install certain installation utilities or tools. For example, if an installation tool “ABC” is to be supported for a particular installation package, an ABCCommandLine subclass may be defined. Instances of this class then provide information specific to the needs of the ABC tool. A variety of installation tools may be supported for each installation package by defining and populating multiple such classes. Preferably, instances of these classes reference a resource or resource bundle which specifies the syntax of the command line invocation. (Alternatively, the information may be stored directly in the instance.)

Instances of the CommandLineModel class 310 preferably also specify the response file information (or a reference thereto), enabling automated access to default response values during the installation process. In addition, these instances preferably specify how to obtain information about the success or failure of an installation process. This information may comprise identification of particular success and/or failure return codes, or the location (e.g. name and path) of a log file where messages are logged during an installation. In the latter case, one or more textual strings or other values which are designed to be written into the log file to signify whether the installation succeeded or failed are preferably specified as well. These string or other values can then be compared to the actual log file contents to determine whether a successful installation has occurred. For example, when an installation package is designed to install a number of software components in succession, it may be necessary to terminate the installation if a failure is encountered for any particular component. The installation engine of the present invention may therefore automatically determine whether each component successfully installed before proceeding to the next component.

Additional information may be specified in instances of CommandLineModel, such as timer-related information to be used for monitoring the installation process. In particular, a timeout value may be deemed useful for determining when the installation process should be considered as having timed out, and should therefore be terminated. One or more timer values may also be specified that will be used to determine such things as when to check log files for success or failure of particular interim steps in the installation.

Instances of a Capabilities class 320 are used to specify the capabilities or functions a software component provides. Capabilities thus defined may be used to help an installer select among components provided in an installation package, and/or may be used to programmatically enforce install-time checking of variable dependencies. As an example of the former, suppose an installation package includes a number of printer driver software modules. The installer may be prompted to choose one of these printer drivers at installation time, where the capabilities can be interrogated to provide meaningful information to display to the installer on a selection panel. As an example of the latter, suppose Product A is being installed, and that Product A requires installation of Function X. The installation package may contain software for Product B and Product C, each of which provides Function X. Capabilities are preferably used to specify the functions provided by Product B and Product C (and Dependencies class 360, discussed below, is preferably used to specify the functions required by Product A). The installation engine can then use this information to ensure that either Product B or Product C will be installed along with Product A.

As disclosed in the related inventions, ProductDescription class 330 is preferably designed as a container for various types of product information. Examples of this product information include the software vendor, application name, and software version of the software component. Instances of this class are preferably operating-system specific. The locations of icons, sound and video files, and other media files to be used by the product (during the installation process, and/or at run-time) may be specified in instances of ProductDescription. For licensed software, instances of this class may include licensing information such as the licensing terms and the procedures to be followed for registering the license holder. When an installation package provides support for multiple natural languages, instances of ProductDescription may be used to externalize the translatable product content (that is, the translatable information used during the installation and/or at run-time). This information is preferably stored in a resource bundle (or other type of external file or document, referred to herein as a resource bundle for ease of reference) rather than in an object instance, and will be read from the resource bundle on an on-demand basis.

The InstallFileSets class 340 is used in preferred embodiments of the object model disclosed in the related inventions as a container for information that relates to the media image of a software component. Instances of this class are preferably used to specify the manifest for a particular component. Tens or even hundreds of file names may be included in the manifest for installation of a complex software component. Resource bundles are preferably used, rather than storing the information directly in the object instance.

The related inventions disclose use of the VariableModel class 350 as a container for attributes of variables used by the component being installed. For example, if a user identifier or password must be provided during the installation process, the syntactical requirements of that information (such as a default value, if appropriate; a minimum and maximum length; a specification of invalid characters or character strings; etc.) may be defined for the installation engine using an instance of VariableModel class. In addition, custom or product-specific validation methods may be used to perform more detailed syntactical and semantic checks on values that are supplied (for example, by the installer) during the installation process. As disclosed for an embodiment of the related inventions, this validation support may be provided by defining a CustomValidator abstract class as a subclass of VariableModel, where CustomValidator then has subclasses for particular types of installation variables. Examples of subclasses that may be useful include StringVariableModel, for use with strings; BooleanVariableModel, for use with Boolean input values; PasswordVariableModel, for handling particular password entry requirements; and so forth. Preferably, instances of these classes use a resource bundle that specifies the information (including labels, tooltip information, etc.) to be used on the user interface panel with which the installer will enter a value or values for the variable information.

Dependencies class 360 is used to specify prerequisites and co-requisites for the installation package, as disclosed in the related inventions. Information specified as instances of this class, along with instances of the Capabilities class 320, is used at install time to ensure that the proper software components or functions are available when the installation completes successfully.

The related inventions disclose providing a Conflicts class 370 as a mechanism to prevent conflicting software components from being installed on a target device. For example, an instance of Conflicts class for Product A may specify that Product Q conflicts with Product A. Thus, if Product A is being installed, the installation engine will determine whether Product Q is installed (or is selected to be installed), and generate an error if so.

VersionCheckerModel class 380 is provided to enable checking whether the versions of software components are proper, as disclosed in the related inventions. For example, a software component to be installed may require a particular version of another component.

The related invention which is titled “Efficient Installation of Software Packages” (and which is referred to hereinafter as “the conditional installation invention”) defines an additional class, “IncrementalInstall”, which has not been shown in FIG. 3. As disclosed in this conditional installation invention, Incrementallnstall is a subclass of ProductModel and may be used to provide a conditional installation of the corresponding software component. (Alternatively, this information may be represented within one or more of the previously-defined classes.) The conditional installation invention provides examples of using a conditional installation, and also defines a suite-level IncrementalInstall class which is a subclass of the Suite object described below with reference to FIG. 4. Refer to this conditional installation invention for a detailed discussion of these classes and their use.

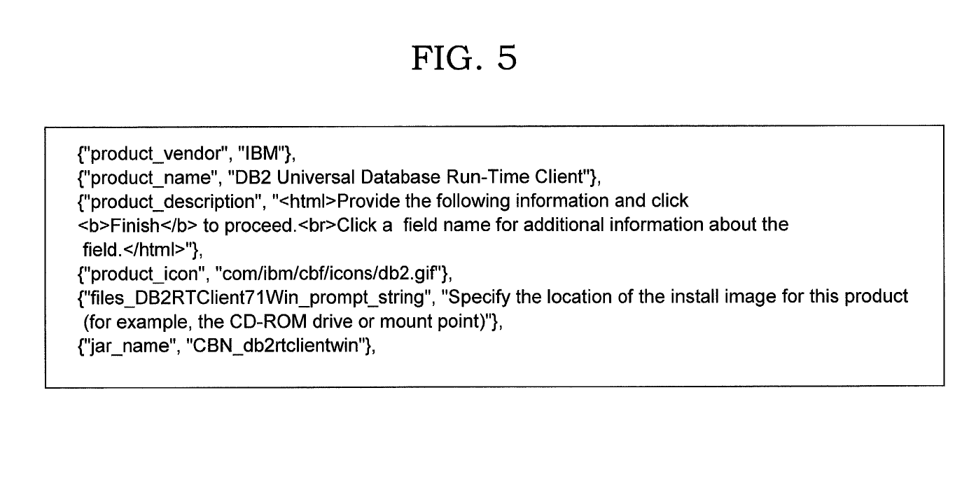

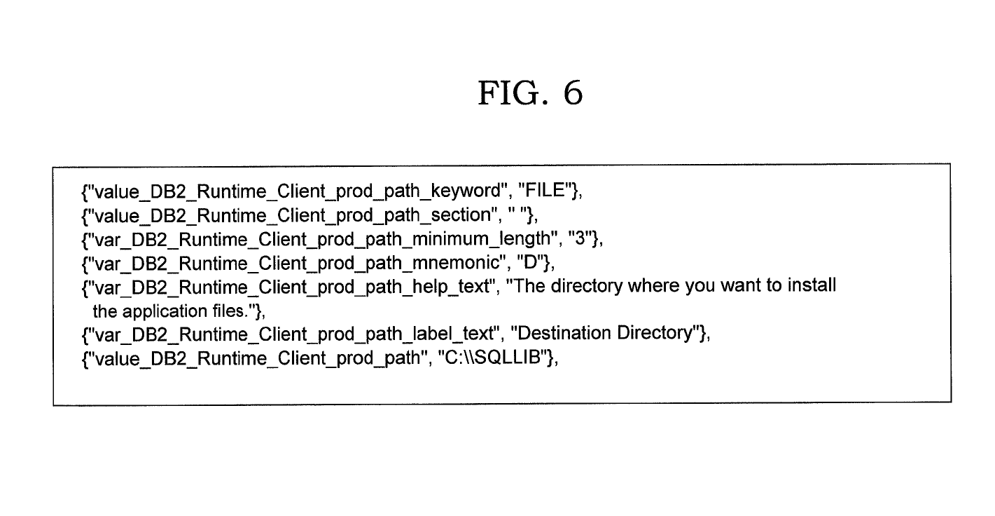

Preferably, the resource bundles referenced by the software components of the present invention are structured as product resource bundles and variable resource bundles. Examples of the information that may be specified in product resource bundles (comprising values to be used by instances of CommandLineModel 310, etc.) and in variable resource bundles (with values to be used by instances of VariableModel 350, ProductDescription 330, etc.) are depicted in FIGS. 5 and 6, respectively. (Note that while 2 resource bundles are shown for the preferred embodiment, this is for purposes of illustration only. The information in the bundles may be organized in many different ways, including use of a separate bundle for each class. When information contained in the bundles is to be translated into multiple natural languages, however, it may be preferable to limit the number of such bundles.)

Referring now to FIG. 4, an object model as disclosed in the related inventions for representing an installation suite comprising all the components present in a particular installation package, and enhancements thereto which may be made for the present invention, will now be described. A Suite 400 object class serves as a container of containers, with each instance containing a number of suite-level specifications in subclasses shown generally at 410 through 470. Each suite object also contains one or more instances of ProductModel 300 class, one for each software component in the suite. The Suite class may be used to enforce consistency among software components (by handling the inter-component prerequisites and co-requisites), and to enable sharing of configuration variables among components. (Furthermore, as disclosed in the conditional installation invention, the Suite class 400 may contain suite-level information to be used in a conditional installation, as described therein.)

According to the present invention, instances of ProductModel which are contained in Suite 400, as well as instances of the other subclasses 410 through 470, use a logical containment relationship as has been described earlier. These instances may therefore be separately stored in the directory and assembled into a complete installation suite at run-time after the target user's access rights are determined.

SuiteDescription class 410 is defined in the related inventions as a descriptive object which may be used as a key when multiple suites are available for installation. Instances of SuiteDescription preferably contain all of the information about a suite that will be made available to the installer. These instances may also provide features to customize the user interface, such as build boards, sound files, and splash screens.

As disclosed in the related inventions, ProductCapabilities class 420 provides similar information as Capabilities class 320, and may be used to indicate required or provided capabilities of the installation suite.

ProductCategory class 430 is defined in the related inventions for organizing software components (e.g. by function, by marketing sector, etc.). Instances of ProductCategory are preferably descriptive, rather than functional, and are used to organize the display of information to an installer in a meaningful way. A component may belong to multiple categories at once (in the same or different installation suites).

As disclosed in the related inventions, instances of ProductGroup class 440 are preferably used to bundle software components together for installation. Like an instance of ProductCategory 430, an instance of ProductGroup groups products; unlike an instance of ProductCategory, it then forces the selection (that is, the retrieval and assembly from the directory) of all software components at installation time when one of the components in the group (or an icon representing the group) is selected. The components in a group are selected when the suite is defined, to ensure their consistency as an installation group.

Instances of VariableModel class 450 provide similar information as VariableModel class 350, as discussed in the related inventions, and may be used to specify attributes of variables which pertain to the installation suite.

VariablePresentation class 460 is used, according to the related inventions, to control the user interface displayed to the installer when configuring or customizing an installation package. One instance of this class is preferably associated with each instance of VariableModel class 450. The rules in the VariableModel instance are used to validate the input responses, and these validated responses are then transmitted to each of the listening instances of VariableLinkage class 470.

As disclosed in the related inventions, instances of VariableLinkage class 470 hold values used by instances of VariableModel class 450, thereby enabling sharing of data values. VariableLinkage instances also preferably know how to translate information from a particular VariableModel such that it meets the requirements of a particular ProductModel 300 instance.

Each instance of ProductModel class 300 in a suite is preferably independently serializable, as discussed in the related inventions. According to the present invention, however, the objects which make up an instance of ProductModel may be separately stored in a directory, and may be assembled into a complete ProductModel instance when the user's access rights are determined (which typically occurs at run-time, when the user requests delivery of an installation suite). Alternatively, some combination of the objects which make up an instance may be separately stored, or an entire ProductModel instance may be stored in the directory, depending on the needs of a particular installation scenario. After assembling or retrieving each ProductModel instance, the various ProductModel instances making up the suite are merged with other such assembled or retrieved instances comprising an instance of Suite 400, according to the present invention.

During the customization process, an installer may select a number of physical devices or machines on which software is to be installed from a particular installation package. Furthermore, he may select to install individual ones of the software components provided in the package. This is facilitated by defining a high-level object class (not shown in FIGS. 3 or 4) which is referred to herein as “Groups”, which is a container for one or more Group objects. A Group object may contain a number of Machine objects and a number of ProductModel objects (where the ProductModel objects describe the software to be installed on those machines, according to the description of FIGS. 3 and 4). Machine objects preferably contain information for each physical machine on which the software is to be installed, such as the machine's Internet Protocol (IP) address and optionally information (such as text for an icon label) that may be used to identify this machine on a user interface panel when displaying the installation package information to the installer.

When using JavaBeans of the Java programming language to implement installation objects according to the installation object model, the object attributes and methods to be used for installing a software package are preferably specified as properties and methods of the JavaBeans. A JavaBean is preferably created for each version of each software component to be included in a particular software installation package, as well as another JavaBean for each version of the overall installation suite. When using Object REXX, the object attributes and methods to be used for installing a software package are preferably specified as properties and methods in Object REXX. When using structured documents, the object attributes and methods are preferably specified as elements in the structured documents. (Refer to the related inventions for a detailed discussion of these approaches.)

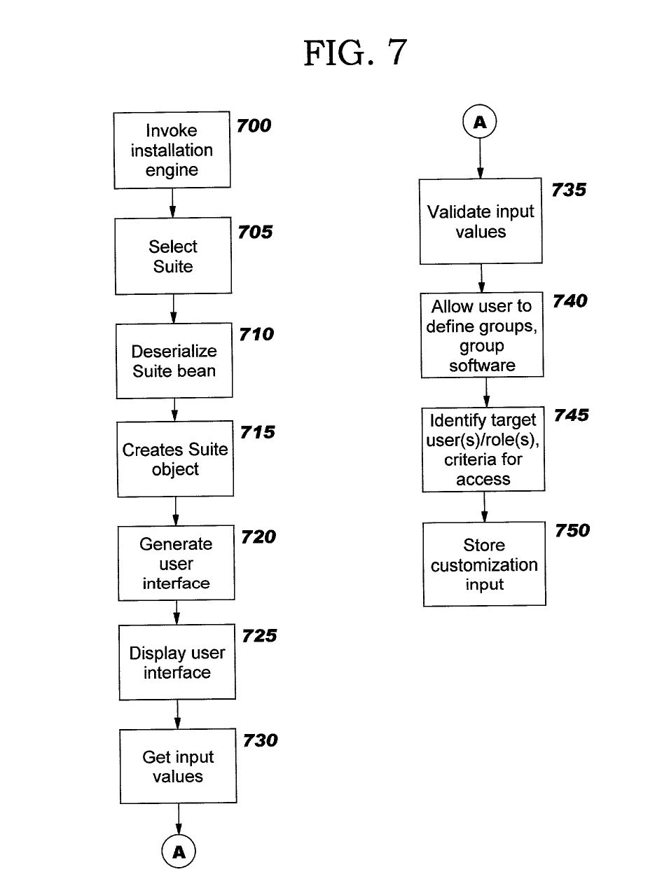

The process of customizing a software installation package for use in a particular target environment, building the component (i.e. ProductModel) objects and Suite object once the user's access rights are determined, and then performing the installation according to the present invention will now be described with reference to the flowcharts in FIGS. 7 through 10. (These processes may be performed in succession during one invocation of the installation engine of the present invention, or may be separated in time by invoking individual ones of these functions in the installation engine.) It should be noted that the related inventions have disclosed a general software installation process using the model and framework of their respective FIGS. 3 and 4, and preferred embodiments of logic which may be used to implement this installation process have been described therein with reference to their respective FIGS. 7 through 10. The discussion of the logic underlying the installation process in FIGS. 7 through 10 is repeated herein to establish a context for describing the present invention. Alterations to this processing to support the present invention are also described within the overall context of these figures.

Furthermore, the optional caching technique which was disclosed in the conditional installation invention may be used with the present invention if desired, and is preferably reflected during processing of those operations which refer to downloading information to a target machine: when using caching, this downloading may be avoided if a suitable copy of a selected installation object or component to be downloaded is available from cache. It will be obvious to one of skill in the art how the logic which is depicted may be modified to provide this caching optimization. Refer to the conditional installation invention for more information on the caching technique disclosed therein.

A software installer or other person such as a systems administrator who is authorized to customize a suite according to particular access rights (referred to hereinafter as “the installer”) invokes the installation engine (Block 700), and then selects a particular software suite to be customized (Block 705). (In some environments, the authority to customize an installation suite according to particular access rights may not be given to all software installers, but may be given only to installers with some type of administrative authority. It will be obvious to those of skill in the art that references to a “software installer” herein are not meant to imply that every installer is permitted to use the function being described.) The corresponding Suite bean is retrieved from the directory and deserialized (Block 710), as required, creating a Suite object (Block 715). Using information previously stored in the Suite object, a user interface is generated (Block 720). One or more ProductModel beans which comprise the Suite bean may also be retrieved from the directory and deserialized at this time, if they are stored independently, and information from the resulting ProductModel objects may be used when generating the user interface. For example, a generated user interface may present a name and descriptive information about the suite (using the SuiteDescription 410 instance), and a name and descriptive information for each component in the suite (using ProductDescription 330 instances).

The generated user interface is then displayed (Block 725) to the installer. Customization values are then accepted from the installer (Block 730). Optionally, when the techniques of the conditional installation invention are implemented, the installer may provide information that will subsequently be used during the conditional installation process, as described therein. At Block 735, the input data is validated using the methods specified in instances of a CustomValidator abstract class. (Refer to the discussion of VariableModel class 350, above, for more information on CustomValidator.) An iterative approach is preferably used for accepting and validating the input data.

When the data entry and validation is complete, control reaches Block 740, where the installer is allowed to define groups of target machines, and to select particular software components from the suite that are to be associated with an installation to that group of machines. In addition, the installer identifies any conditions or criteria, as necessary, regarding what to make available to the target users based on their access rights (Block 745). This information is then stored in a Group object in a directory-style format at Block 750. If the customized suite is not to be built or installed at this time, the object is preferably serialized (not shown in FIG. 7). The Groups object, which is a container for one or more Group objects, is preferably serialized in an initialization file (having the suffix “.ini”) Thus, customization of software and information to be presented on the user interface panel to the installer is preserved in a text file for later use during the installation process.

Note that while FIG. 7 describes customizing an installation package for an entire suite, an installer may also be allowed to individually customize the objects or components of the suite. Based on the description of FIG. 7, it will be obvious to one of ordinary skill in the art how this logic may be structured.

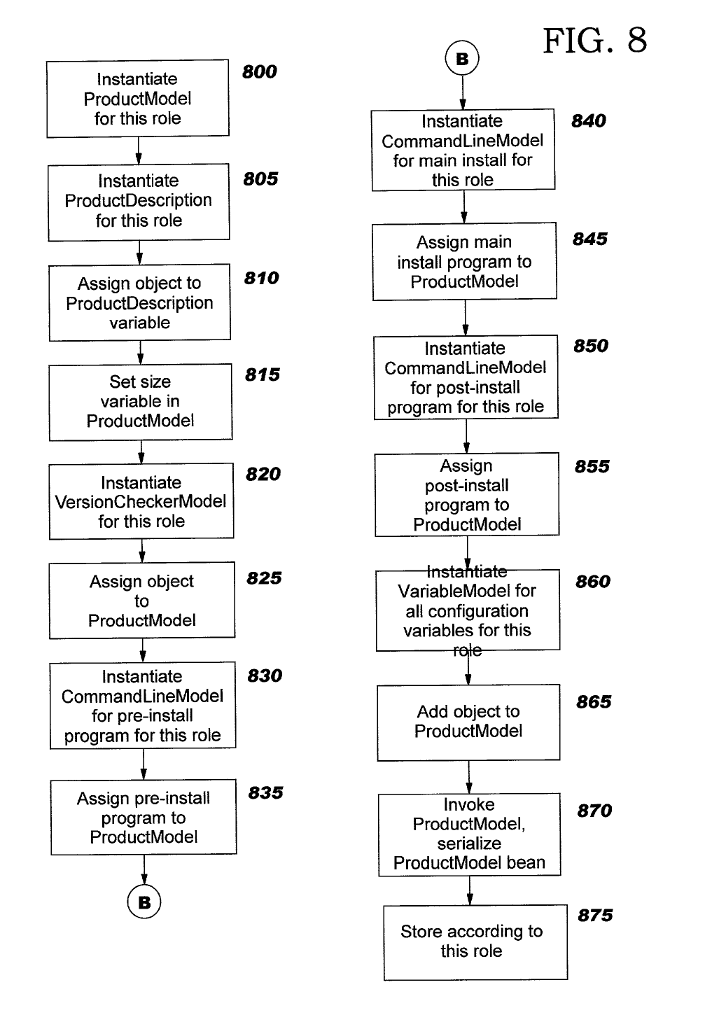

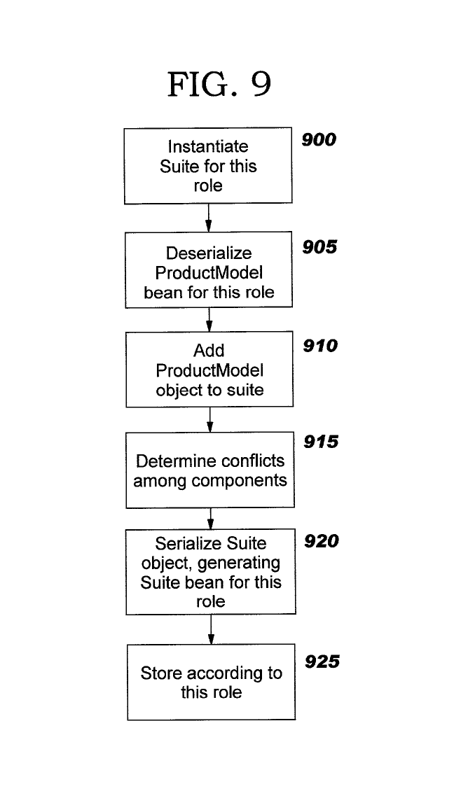

When the installer is ready to build an installation package reflecting the customized information, a build process is performed to assemble the objects for each ProductModel object and then for the Suite object. These processes are illustrated in FIGS. 8 and 9, respectively.

The build process for a ProductModel bean begins at Block 800, where ProductModel 300 is instantiated for a particular role (i.e. a particular set of access rights). At Block 805, ProductDescription is then instantiated for this particular role, and the resulting object is assigned (Block 810) to a ProductDescription variable of the ProductModel object.

It should be noted that in an object-based embodiment of the present invention, the instantiations described with reference to FIG. 8 are instantiations only of classes, and that internal variables are not being directly set. This is because, in preferred embodiments, the classes ProductDescription, VersionCheckerModel, CommandLineModel, and VariableModel get their variable information from a resource bundle rather than through variable settings within an object. In a structured document-based embodiment, the discussions of instantiations preferably represent parsing of documents that hold the values of properties or attributes of these elements.

Next, a size variable of ProductModel is set to the installed size of this software component (Block 815). VersionCheckerModel is then instantiated (Block 820) for this particular role, and the resulting object is assigned (Block 825) to ProductModel. Preferably, this assignment comprises issuing a “setVersionChecker (VersionCheckerModel)” call (or a call having similar syntax).

Block 830 instantiates CommandLineModel 310, or one of its subclasses for a particular installation environment (as discussed above), for the pre-install program in this particular role and assigns the resulting object to ProductModel at Block 835. This assignment preferably comprises issuing a call having syntax such as “setPreInstall (CommandLineModel)”. In preferred embodiments, custom programs may be invoked to perform integration of a suite in its target environment, and/or integration of individual ones of the components. The particular custom programs to be invoked are thus defined using instances of CommandLineModel, in the same manner that a CommandLineModel instance defines how to invoke the installation of each particular component. Issuing the “setPreInstall” call establishes the custom program that is to be executed prior to installing this component (and may be omitted when there is no such program). Another instance of CommandLineModel (or a subclass) is then instantiated for this particular role and assigned to ProductModel to specify invocation information for installation of the component itself (Blocks 840 and 845). The assignment may be performed using call syntax such as “setInstall (CommandLineModel)”. If a custom post-installation integration program is to be executed, Blocks 850 and 855 instantiate the proper object for this particular role and assign it to ProductModel using a call with syntax such as “setPostInstall (CommandLineModel)”.

For each configuration variable of this component, a subclass of VariableModel is instantiated (Block 860) for this particular role and added to ProductModel (Block 865). An instance of IncrementalInstall class in ProductModel 300 may be instantiated and added to ProductModel (not shown in FIG. 8) if a component-level conditional installation is defined for this component according to the conditional installation invention. Finally, an invocation of ProductModel is performed (Block 870), which generates a serialized output ProductModel bean that is stored in the directory at the appropriate level or hierarchy, such that the stored entry is associated with the set of access rights for this particular role.

The build process for a Suite bean begins at Block 900 of FIG. 9, where Suite 400 is instantiated for this particular role. For each component in the suite, the ProductModel bean for this particular role is deserialized (Block 905) and the resulting ProductModel object is added (Block 910) to a vector of suite products. An instance of IncrementalInstall class in Suite 400 is instantiated and added to Suite 400 (not shown in FIG. 9) if a suite-level conditional installation is defined for this suite. Block 915 determines whether any of the products in the suite conflict with one another, using the information stored in each Conflicts class 370. Assuming that all conflicts are resolved, Block 920 serializes the Suite object to generate an output Suite bean for this particular role. This Suite bean is then stored in the directory (Block 925) in association with the set of access rights for this particular role.

FIG. 10 depicts a preferred embodiment of logic with which the installation time processing may be performed. This processing is described in terms of installation from a directory server on which one or more versions of the suite beans and component beans, as well as their objects, are stored (or are otherwise accessible), across a network to one or more target devices. It will obvious to one of ordinary skill in the art how the process of FIG. 10 may be altered for use in other installation scenarios, including installation on a stand-alone machine which is not connected to a network, or a local installation where the client and server are co-resident.

The installation process of FIG. 10 begins with a requesting client initiating the installation process (Block 1000), for example by selecting a suite from a user interface display after invoking a software installation task. The requesting client's device then sends a request to the directory server (Block 1005) for the Suite object which corresponds to the selected suite. At Block 1010, the directory server receives this request, and preferably begins an authentication process whereby the requesting client's authority to receive the requested Suite object is determined. (Note that in alternative embodiments, this authentication process may be omitted, for example in scenarios where all users are permitted to receive an installation object.). When authentication is being performed, the directory server then preferably issues a challenge to the requesting client (Block 1012). In preferred embodiments, this authentication process comprises using public key encryption techniques whereby the requesting client will sign the received challenge (Block 1015) using the client's private key of a previously-created public/private key pair and return this signed challenge to the directory server. When the directory server receives the requesting client's signed response (Block 1020),the directory server validates the signature using the client's public key to authenticate the requester. (Techniques for performing authentication using signed messages in this manner are well known in the art, and will not be described further herein.)

If the authentication is successful, or if the requesting client's access rights are determined without authentication (for example, by conveying an identification of the user in the request sent at Block 1005), the directory server then uses the access rights which are associated with this requester in the directory to locate a Suite object which is associated with those access rights, and returns that Suite object (Block 1025). This Suite object will contain one or more component objects which are associated with the access rights for installation on this requester's client device. As discussed in the conditional installation invention, it may happen that the client lacks required resources or is otherwise unable or unwilling to perform a particular suite installation process. In that case, the optimization defined therein may be performed if desired, whereby a checking process is performed before transmitting the entire Suite object to the client. Refer to the conditional installation invention for a discussion of the process for carrying out this optimization.

Upon receiving the Suite object, the client may then request (Block 1030) delivery of a Machine object. A Machine object contains one or more component objects which are appropriate to this particular type of client device, as previously described (and which may be specific to this requester's access rights). After receiving this request, the directory server returns the Machine object to the requester (Block 1035).

When the requested object is received, the client preferably sorts the component objects according to a priority value that may be specified in ProductModel, and/or dependencies on other components (Block 1040). Block 1045 then begins an iterative process that extends through Block 1075, and which is performed for each component that is to be installed. At Block 1045, the client sends a request to the directory server for the jar (i.e. the Java Archive, or serialized ProductModel) file for this component. The server receives this request (Block 1050), and returns the component's jar file which is appropriate for this requester's access rights to the client. Additional checking processes may be performed if conditional installation is being performed according to the conditional installation invention.

Upon receiving the jar file, the client executes the pre-install program (Block 1055), if one has been defined. Block 1060 then executes the installation of the component itself, and Block 1070 executes the post-install program, if one has been defined for this component. (Refer to the description of Blocks 830 through 855, above, for more information on pre- and post-install programs.)

The status of the component installation is returned to the directory server (Block 1070). If a log file was defined for this purpose, as previously described, the log file is also returned (Block 1075).

When all components have been installed (or a decision has been made according to the conditional installation invention that selected components are not to be installed), control reaches Block 1080. The client preferably sends a “Suite installation complete” message to the directory server. Optionally, this message may contain a summary (or list or other identification) of the components which were newly installed; or, conversely, it may include a summary of the components for which installation was not performed, according to the process of the conditional installation invention. Upon receiving this message, the directory server issues a message to the client (Block 1085), telling it to close down the installation process. The client, upon receiving this message, performs termination logic such as removing the installation user interface (Block 1090). The client then resets and waits on its RMI port (Block 1095). (In preferred embodiments, HTTP message exchanges are used for transferring relatively large amounts of data; RMI is used for lightweight message exchange.) The installation processing then ends.

As has been demonstrated, the present invention defines an improved installation process using an object model and framework that provides a standard, consistent approach to software installation across many variable factors such as product and vendor boundaries, computing environment platforms, and the language of the underlying code as well as the preferred natural language of the installer. Use of the techniques disclosed herein uncouples the objects of the data model from the framework, allowing individual objects to be separately stored and retrieved, as has been described. By storing installation objects in a directory, multiple versions of each object may be created and stored and may be easily retrieved using the built-in mechanisms of the directory, thereby providing installation suites that are automatically adapted to the access rights of a particular situation.

While preferred embodiments of the present invention have been described, additional variations and modifications in that embodiment may occur to those skilled in the art once they learn of the basic inventive concepts. Therefore, it is intended that the appended claims shall be construed to include preferred embodiments as well as all such variations and modifications as fall within the spirit and scope of the invention.

What is claimed is:

1. A method of improving installation of software packages, comprising steps of:
defining an object model representing a plurality of components of a software installation package, wherein each component comprises a plurality of objects;
instantiating at least one version of each of the objects, wherein a plurality of versions of selected ones of the objects may be instantiated to reflect differing access rights which are appropriate for potential requesters of the package; and
storing the instantiated objects in a directory, wherein the versions of the objects are associated with the differing access rights.

2. The method according to claim 1, further comprising the step of populating the instantiated objects with attributes and methods to describe a particular software installation package.

3. The method according to claim 1, further comprising steps of:
receiving a request from a particular requester for a selected software installation package;
determining the access rights which are appropriate for the particular requester; and
retrieving the selected software installation package from the directory, wherein the retrieved package is dynamically assembled from the stored objects based upon the determined access rights.

4. The method according to claim 3, further comprising steps of:
authenticating the particular requester, in response to receiving the request; and
determining the access rights and retrieving the selected software installation package only if the authentication succeeds..

5. The method according to claim 3, further comprising the step of installing the retrieved software installation package.

6. The method according to claim 1, wherein the instantiated objects are JavaBeans.

7. The method according to claim 1, wherein the directory is a Lightweight Directory Access Protocol (“LDAP”) directory.

8. A system for improving installation of software packages, comprising:
means for defining an object model representing a plurality of components of a software installation package, wherein each component comprises a plurality of objects;
means for instantiating at least one version of each of the objects, wherein a plurality of versions of selected ones of the objects may be instantiated to reflect differing access rights which are appropriate for potential requesters of the package; and
means for storing the instantiated objects in a directory, wherein the versions of the objects are associated with the differing access rights.

9. The system according to claim 8, further comprising:
means for receiving a request from a particular requester for a selected software installation package;
means for the determining access rights which are appropriate for the particular requester; and
means for retrieving the selected software installation package from the directory, wherein the retrieved package is dynamically assembled from the stored objects based upon the determined access rights.

10. A computer program product for improving installation of software packages, the computer program product embodied on one or more computer-readable media and comprising:
computer-readable program code means for defining an object model representing a plurality of components of a software installation package, wherein each component comprises a plurality of objects;
computer-readable program code means for instantiating at least one version of each of the objects, wherein a plurality of versions of selected ones of the objects may be instantiated to reflect differing access rights which are appropriate for potential requesters of the package; and
computer-readable program code means for storing the instantiated objects in a directory, wherein the versions of the objects are associated with the differing access rights.

11. The computer program product according to claim 10, further comprising:
computer-readable program code means for receiving a request from a particular requester for a selected software installation package;
computer-readable program code means for the determining access rights which are appropriate for the particular requester; and
computer-readable program code means for retrieving the selected software installation package from the directory, wherein the retrieved package is dynamically assembled from the stored objects based upon the determined access rights.
